(19) United States
(12) Patent Application Publication
(10) Pub. No.: US 2025/0343845 A1
(43) Pub. Date: Nov. 6, 2025

(54) DESIGNS OF MULTI-RU IN WIDER BANDWIDTH PPDU FOR NEXT-GENERATION WLAN

(71) Applicant: MEDIATEK INC., Hsinchu City (TW)

(72) Inventors: Shengquan HU, San Jose, CA (US); Jianhan LIU, San Jose, CA (US); Thomas Edward PARE, JR., San Jose, CA (US)

(21) Appl. No.: 18/870,696

(22) PCT Filed: Jun. 9, 2023
(86) PCT No.: PCT/CN2023/099510

§ 371 Date: Dec. 2, 2024

Related U.S. Application Data
(60) Provisional application No. 63/350,912, filed on Jun. 10, 2022.

(51) Int. Cl. H04L 69/323; H04L 27/26

(52) U.S. Cl. CPC H04L 69/323; H04L 27/26414

(57) ABSTRACT

Techniques pertaining to designs of multi-resource unit (multi-RU) in wider bandwidth physical-layer protocol data unit (PPDU) for next-generation wireless local area networks (WLANs) are described. An apparatus (e.g., station (STA)) generates one or more small-size multi-resource units (MRUs) or one or more large-size MRUs, or a combination thereof, of a PPDU in a wide bandwidth greater than 80MHz. The apparatus then wirelessly transmits the PPDU in the wide bandwidth. Each of the one or more small-size MRUs includes an aggregate of multiple RUs of 106 tones or fewer. Each of the one or more large-size MRUs includes an aggregate of multiple RUs of 242 tones or more.

### CROSS REFERENCE TO RELATED PATENT APPLICATION

The present disclosure is part of a non-provisional patent application claiming the priority benefit of U.S. Provisional Patent Application Nos. 63/350,912, filed 10 Jun. 2022, the content of which herein being incorporated by reference in its entirety.

### TECHNICAL FIELD

The present disclosure is generally related to wireless communications and, more particularly, to designs of multi-resource unit (multi-RU) in wider bandwidth physical-layer protocol data unit (PPDU) for next-generation wireless local area networks (WLANs).

### BACKGROUND

Unless otherwise indicated herein, approaches described in this section are not prior art to the claims listed below and are not admitted as prior art by inclusion in this section.

In wireless communications such as Wi-Fi (or WiFi) in accordance with the Institute of Electrical and Electronics Engineers (IEEE) 802.11 standards, wider bandwidth tends to be an efficient way to achieve higher throughputs for next-generation WLANs. However, at the present time, designs of multi-RUs for transmission of PPDUs in wider bandwidths, such as 240MHz, 480MHz, 560MHz and 640MHz, have yet to be defined. Therefore, there is a need for a solution of designs of multi-RU wider bandwidth PPDU for next-generation WLANs.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to provide schemes, concepts, designs, techniques, methods and apparatuses pertaining to designs of multi-RU wider bandwidth PPDU for next-generation WLANs.

In one aspect, a method may involve generating one or more small-size multi-resource units (MRUs) or one or more large-size MRUs, or a combination thereof, of a PPDU in a wide bandwidth greater than 80MHz. The method may also involve wirelessly transmitting the PPDU in the wide bandwidth. Each of the one or more small-size MRUs may include an aggregate of multiple RUs of 106 tones or fewer. Each of the one or more large-size MRUs may include an aggregate of multiple RUs of 242 tones or more.

In another aspect, an apparatus may include a transceiver configured to communicate wirelessly and a processor coupled to the transceiver. The processor may generate one or more small-size MRUs or one or more large-size MRUs, or a combination thereof, of a PPDU in a wide bandwidth greater than 80MHz. The processor may wirelessly transmit, via the transceiver, the PPDU in the wide bandwidth. Each of the one or more small-size MRUs may include an aggregate of multiple RUs of 106 tones or fewer. Each of the one or more large-size MRUs may include an aggregate of multiple RUs of 242 tones or more.

It is noteworthy that, although description provided herein may be in the context of certain radio access technologies, networks and network topologies such as, Wi-Fi, the proposed concepts, schemes and any variation(s)/derivative(s) thereof may be implemented in, for and by other types of radio access technologies, networks and network topologies such as, for example and without limitation, Bluetooth, ZigBee, 5^{th} Generation (5G)/New Radio (NR), Long-Term Evolution (LTE), LTE-Advanced, LTE-Advanced Pro, Internet-of-Things (IoT), Industrial IoT (IIoT) and narrowband IoT (NB-IoT). Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation to clearly illustrate the concept of the present disclosure.

FIG. 1 is a diagram of an example network environment in which various solutions and schemes in accordance with the present disclosure may be implemented.

FIG. 2 is a diagram of an example design under a proposed scheme in accordance with the present disclosure.

FIG. 3 is a diagram of an example design under a proposed scheme in accordance with the present disclosure.

FIG. 4 is a diagram of an example design under a proposed scheme in accordance with the present disclosure.

FIG. 5 is a diagram of an example design under a proposed scheme in accordance with the present disclosure.

FIG. 6 is a diagram of an example design under a proposed scheme in accordance with the present disclosure.

FIG. 7 is a diagram of an example design under a proposed scheme in accordance with the present disclosure.

FIG. 8 is a diagram of an example design under a proposed scheme in accordance with the present disclosure.

FIG. 9 is a block diagram of an example communication system in accordance with an implementation of the present disclosure.

FIG. 10 is a flowchart of an example process in accordance with an implementation of the present disclosure.

### DETAILED DESCRIPTION OF PREFERRED EMBODIMENTS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to designs of multi-RU wider bandwidth PPDU for next-generation WLANs. According to the present disclosure, a number of possible solutions may be implemented separately or jointly. That is, although these possible solutions may be described below separately, two or more of these possible solutions may be implemented in one combination or another.

It is noteworthy that, in the present disclosure, a regular RU (rRU) refers to a RU with tones that are continuous (e.g., adjacent to one another) and not interleaved, interlaced or otherwise distributed. Moreover, a 26-tone regular RU may be interchangeably denoted as RU26 (or rRU26), a 52-tone regular RU may be interchangeably denoted as RU52 (or rRU52), a 106-tone regular RU may be interchangeably denoted as RU106 (or rRU106), a 242-tone regular RU may be interchangeably denoted as RU242 (or rRU242), and so on. Moreover, an aggregate (26+52)-tone regular multi-RU (MRU) may be interchangeably denoted as MRU(26+52) or MRU(52+26) or MRU78 (or rMRU78), an aggregate (26+106)-tone regular MRU may be interchangeably denoted as MRU(26+106) or MRU(106+26) or MRU132 (or rMRU132), and so on.

It is also noteworthy that, in the present disclosure, a bandwidth of 20MHz may be interchangeably denoted as BW20 or BW20M, a bandwidth of 40MHz may be interchangeably denoted as BW40 or BW40M, a bandwidth of 80MHz may be interchangeably denoted as BW80 or BW80M, a bandwidth of 160MHz may be interchangeably denoted as BW160 or BW160M, a bandwidth of 240MHz may be interchangeably denoted as BW240 or BW240M, a bandwidth of 320MHz may be interchangeably denoted as BW320 or BW320M, a bandwidth of 480MHz may be interchangeably denoted as BW480 or BW480M, a bandwidth of 640MHz may be interchangeably denoted as BW640 or BW640M.

It is further noteworthy that, in the present disclosure, the term “small-size MRU” refers to an aggregate of multiple RUs of 26 tones, 52 tones and/or 106 tones. Moreover, the term “large-size MRU” refers to an aggregate of multiple RUs of 242 tones, 484 tones and/or 996 tones.

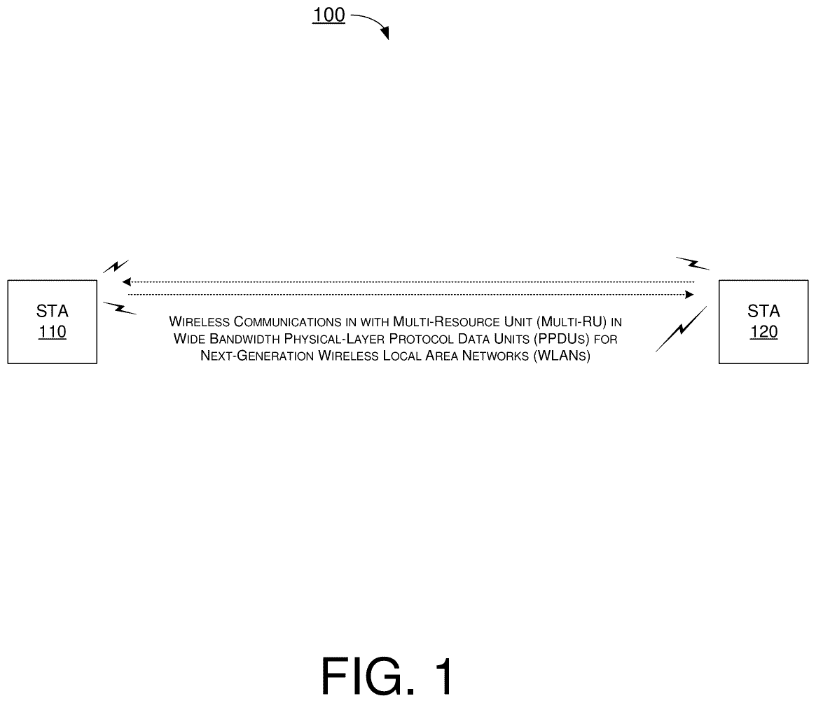

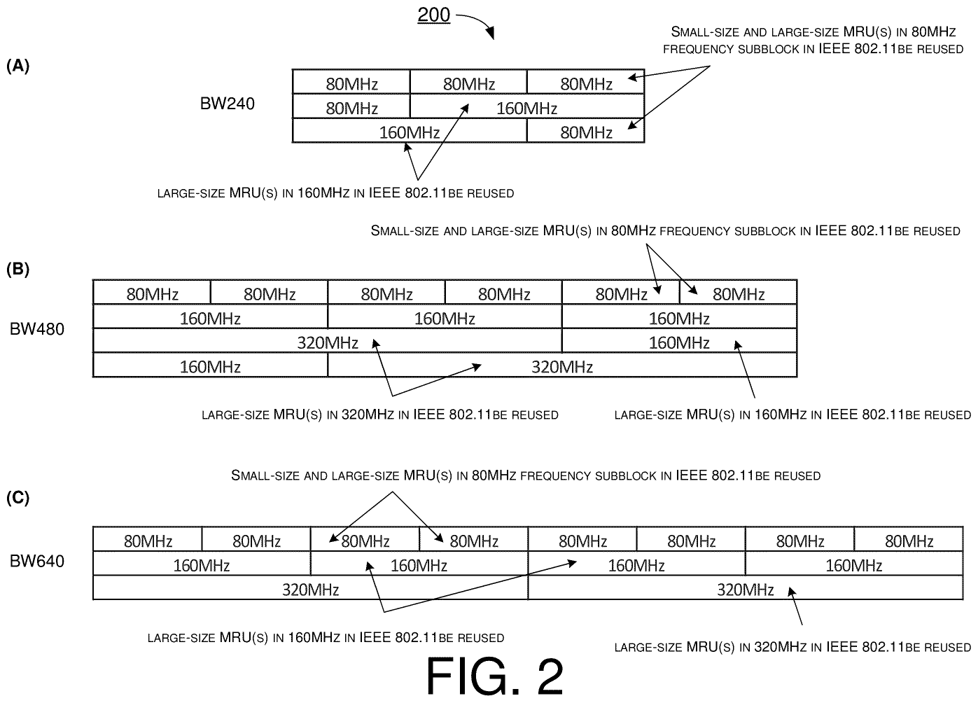

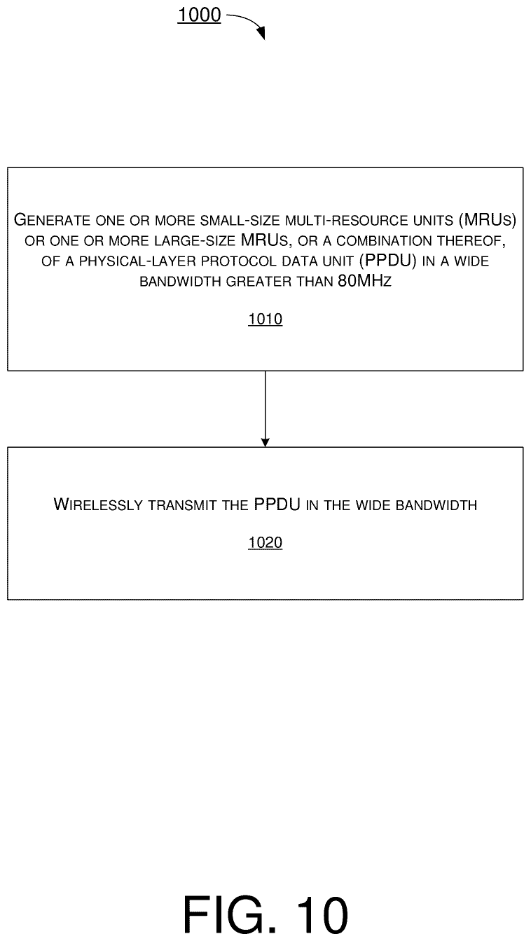

FIG. 1 illustrates an example network environment 100 in which various solutions and schemes in accordance with the present disclosure may be implemented. FIG. 2 ˜ FIG. 10 illustrate examples of implementation of various proposed schemes in network environment 100 in accordance with the present disclosure. The following description of various proposed schemes is provided with reference to FIG. 1 ˜ FIG. 10.

Referring to FIG. 1, network environment 100 may involve at least a station (STA) 110 communicating wirelessly with a STA 120. Either of STA 110 and STA 120 may be a non-access point (non-AP) STA or, alternatively, either of STA 110 and STA 120 may function as an access point (AP) STA. In some cases, STA 110 and STA 120 may be associated with a basic service set (BSS) in accordance with one or more IEEE 802.11 standards (e.g., IEEE 802.11be and future-developed standards). Each of STA 110 and STA 120 may be configured to communicate with each other by utilizing the designs of multi-RU wider bandwidth PPDU for next-generation WLANs in accordance with various proposed schemes described below. That is, either or both of STA 110 and STA 120 may function as a “user” in the proposed schemes and examples described below. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

Under various proposed schemes in accordance with the present disclosure, for wider bandwidths greater than 80MHz, such as 240MHz, 480MHz and 640MHz, small-size MRUs, such as MRU(52+26) and MRU(106+26), may be utilized in each 80MHz frequency subblock of an orthogonal frequency-division multiple-access (OFDMA) 240MHz, 480MHz or 640MHz PPDU. Under the proposed schemes, small-size MRU combinations defined in each 80MHz frequency subblock in the IEEE 802.11be specification may be reused in each 80MHz frequency subblock of BW240/BW480/BW640 PPDU. Moreover, under the proposed schemes, a large-size MRU, MRU(484+242), may be utilized in each 80MHz frequency subblock of an OFDMA 240MHZ, 480MHz or 640MHz PPDU. Under the proposed schemes, the large-size MRU(484+242) combinations defined in each 80MHz subblock in the IEEE 802.11be specification may be reused in each 80MHz frequency subblock of BW240/BW480/BW640 PPDU. Similarly, under the proposed schemes, another large-size MRUs, MRU(996+484) and MRU(996+484+242), may be utilized in each 160MHz frequency subblock of an OFDMA 240MHz, 480MHz or 640MHz PPDU. Under the proposed schemes, the large-size MRU(996+484) and MRU(996+484+242) combinations defined in 160MHz PPDU in the 802.11be specification may be reused in each 160MHz frequency subblock of BW240/BW480/BW640 PPDU. Furthermore, other large-size MRUs, such as MRU(2×996+484), MRU(3×996) and MRU(3×996+484), may be utilized in each 320MHz frequency subblock of an OFDMA 480MHz or 640MHz PPDU. Under the proposed schemes, the large-size MRU (2×996+484), MRU(3×996) and MRU(3×996+484) combinations defined in 320MHz PPDU in the 802.11be may be reused in each 320MHz frequency subblock of BW480/BW640 PPDU. Additionally, other MRUs may be utilized for either OFDMA or non-OFDMA transmissions, and such other MRUs may include, for example and without limitation: MRU(2×996+484) and MRU(2×996) for BW240, MRU(5×996), MRU(4×996) and MRU(3×996) for BW480, and MRU(7×996), MRU(6×996), MRU(5×996) and MRU(4×996) for BW640.

FIG. 2 illustrates an example design 200 under a proposed scheme in accordance with the present disclosure. Part (A) of FIG. 2 shows that different combinations of small-size and large-size MRUs in 80MHz frequency subblocks and large-size MRUs in 160MHz bandwidth, as defined in the IEEE 802.11be specification, may be reused for BW240 in design 200. Part (B) of FIG. 2 shows that different combinations of small-size and large-size MRUs in 80MHz frequency 30 subblocks, large-size MRUs in 160MHz bandwidth, and large-size MRUs in 320MHz bandwidth, as defined in the IEEE 802.11be specification, may be reused for BW480 in design 200. Part (C) of FIG. 2 shows that different combinations of small-size and large-size MRUs in 80MHz frequency subblocks, large-size MRUs in 160MHz bandwidth, and large-size MRUs in 320MHz bandwidth, as defined in the IEEE 802.11be specification, may be reused for BW640 in design 200.

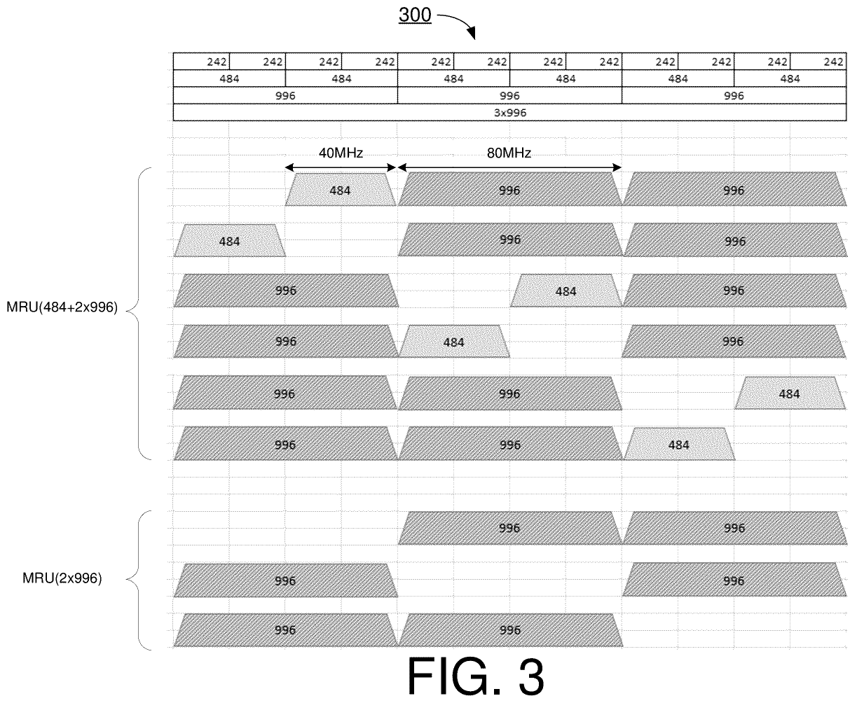

FIG. 3 illustrates an example design 300 under a proposed scheme in accordance with the present disclosure. Referring to FIG. 3, for a wide bandwidth of 240MHz and a subcarrier spacing (SCS) of 78.125 kHz, different arrangements of MRU(484+2×996) and different arrangements of MRU(2×996) may be utilized in design 300.

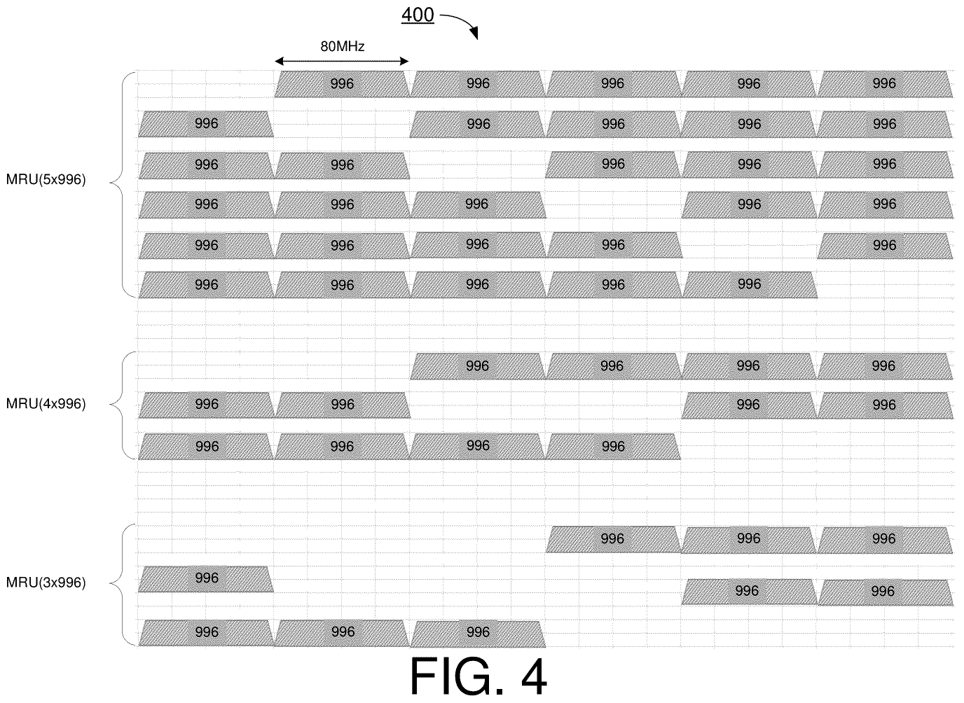

FIG. 4 illustrates an example design 400 under a proposed scheme in accordance with the present disclosure. Referring to FIG. 4, for a wide bandwidth of 480MHz and a SCS of 78.125kHz, different arrangements of MRU(5×996), different arrangements of MRU(4×996) and different arrangements of MRU(3×996) may be utilized in design 400.

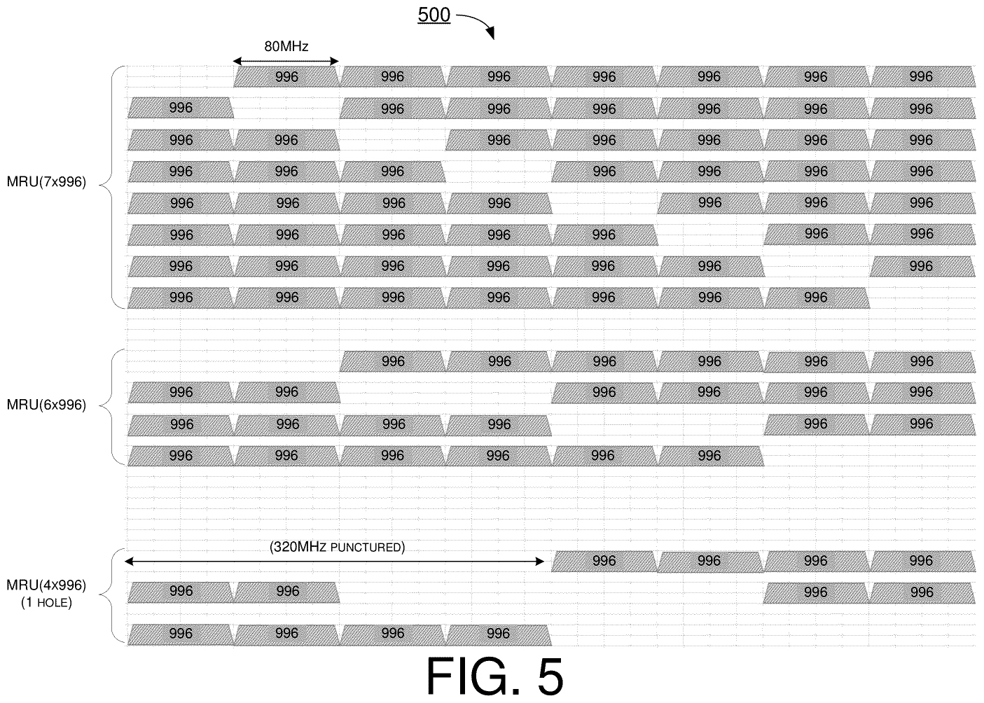

FIG. 5 illustrates an example design 500 under a proposed scheme in accordance with the present disclosure. Referring to FIG. 5, for a wide bandwidth of 640MHz and a SCS of 78.125 kHz, different arrangements of MRU(7×996), different arrangements of MRU(6×996) and different arrangements of MRU(4×996) may be utilized in design 500. In particular, in case of MRU(4×996), there may be a one-hole puncture of 320MHz (e.g., contiguous 32 MHz puncture).

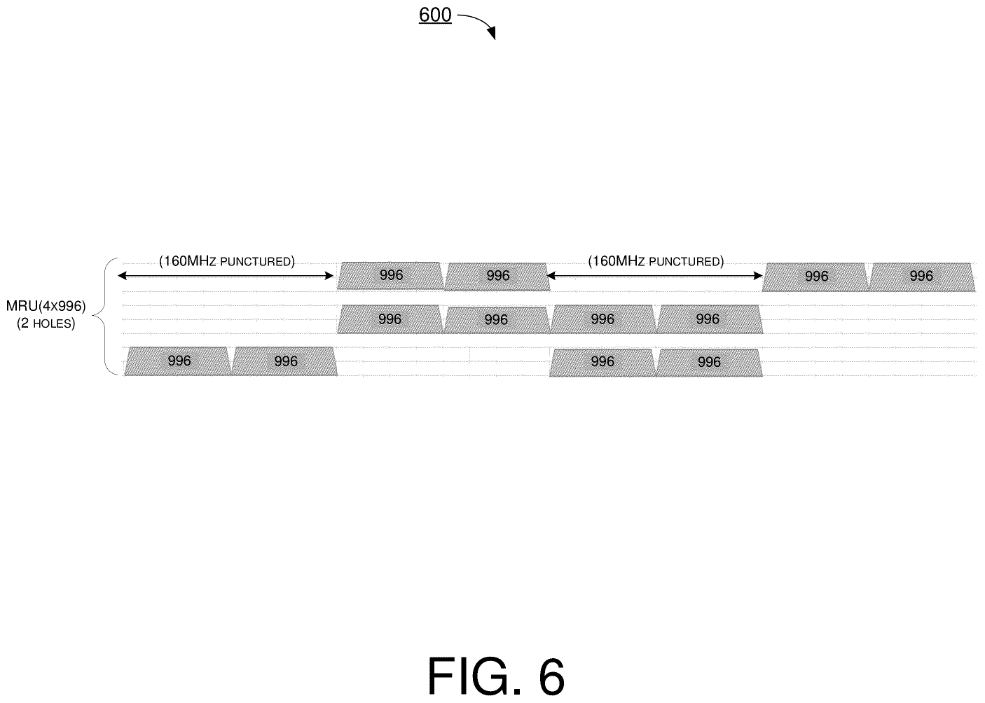

FIG. 6 illustrates an example design 600 under a proposed scheme in accordance with the present disclosure. Referring to FIG. 6, for a wide bandwidth of 640MHz and a SCS of 78.125 kHz, different arrangements of MRU(4×996) may be utilized in design 600. Specifically, there may be two-hole punctures with 160MHz each (e.g., contiguous 160MHz puncture each).

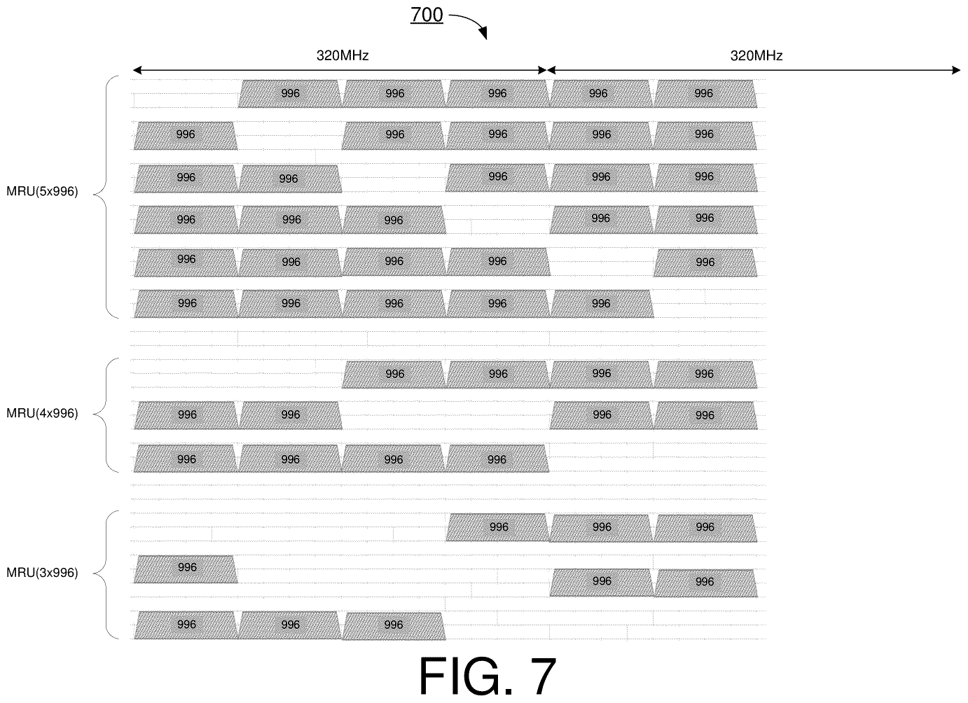

FIG. 7 illustrates an example design 700 under a proposed scheme in accordance with the present disclosure. Referring to FIG. 7, for a wide bandwidth of 640MHz and a SCS of 78.125 kHz, different arrangements of MRU(5×996), different arrangements of MRU(4×996) and different arrangements of MRU(3×996) may be utilized in design 700, considering 480MHz as puncturing a contiguous 160MHz from BW640.

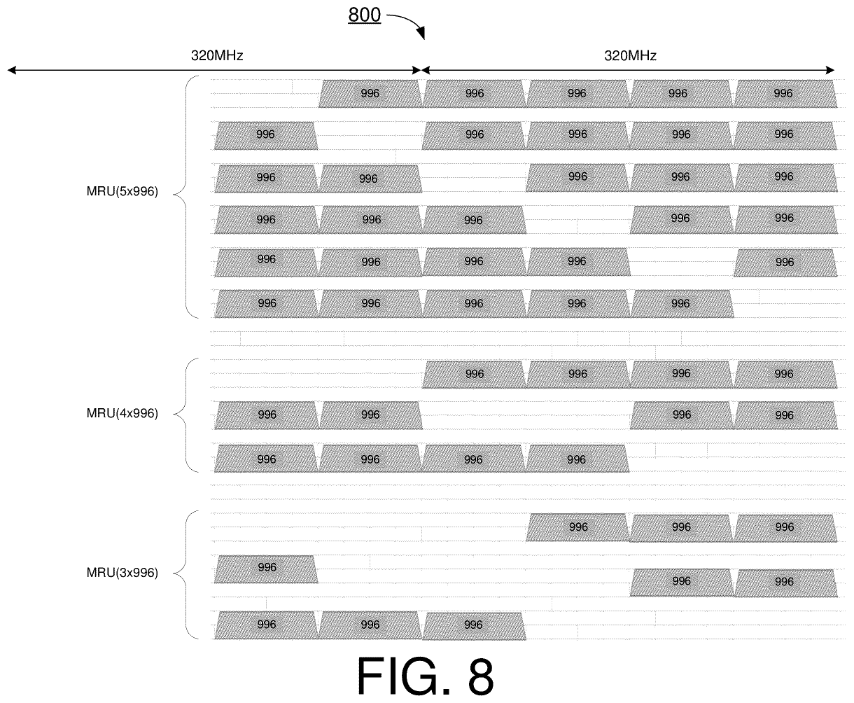

FIG. 8 illustrates an example design 800 under a proposed scheme in accordance with the present disclosure. Referring to FIG. 8, for a wide bandwidth of 640MHz and a SCS of 78.125 kHz, different arrangements of MRU(5×996), different arrangements of MRU(4×996) and different arrangements of MRU(3×996) may be utilized in design 800, considering 480MHz as puncturing a contiguous 160MHz from BW640.

### Illustrative Implementations

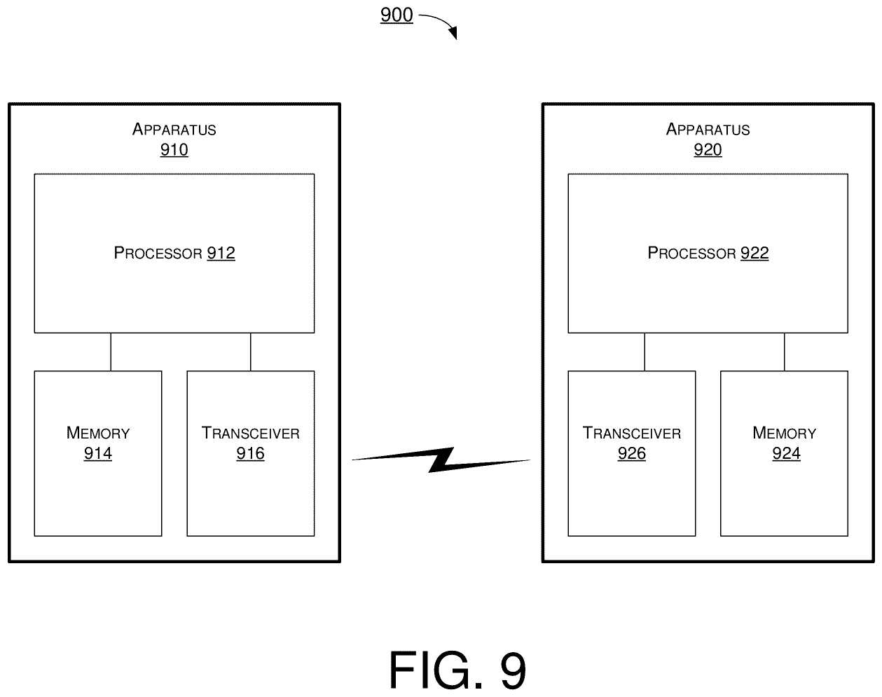

FIG. 9 illustrates an example system 900 having at least an example apparatus 910 and an example apparatus 920 in accordance with an implementation of the present disclosure. Each of apparatus 910 and apparatus 920 may perform various functions to implement schemes, techniques, processes and methods described herein pertaining to designs of multi-RU wider bandwidth PPDU for next-generation WLANs, including the various schemes described above with respect to various proposed designs, concepts, schemes, systems and methods described above as well as processes described below. For instance, apparatus 910 may be implemented in STA 110 and apparatus 920 may be implemented in STA 120, or vice versa.

Each of apparatus 910 and apparatus 920 may be a part of an electronic apparatus, which may be a non-AP STA or an AP STA, such as a portable or mobile apparatus, a wearable apparatus, a wireless communication apparatus or a computing apparatus. When implemented in a STA, each of apparatus 910 and apparatus 920 may be implemented in a smartphone, a smart watch, a personal digital assistant, a digital camera, or a computing equipment such as a tablet computer, a laptop computer or a notebook computer. Each of apparatus 910 and apparatus 920 may also be a part of a machine type apparatus, which may be an IoT apparatus such as an immobile or a stationary apparatus, a home apparatus, a wire communication apparatus or a computing apparatus. For instance, each of apparatus 910 and apparatus 920 may be implemented in a smart thermostat, a smart fridge, a smart door lock, a wireless speaker or a home control center. When implemented in or as a network apparatus, apparatus 910 and/or apparatus 920 may be implemented in a network node, such as an AP in a WLAN.

In some implementations, each of apparatus 910 and apparatus 920 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. In the various schemes described above, each of apparatus 910 and apparatus 920 may be implemented in or as a STA or an AP. Each of apparatus 910 and apparatus 920 may include at least some of those components shown in FIG. 9 such as a processor 912 and a processor 922, respectively, for example. Each of apparatus 910 and apparatus 920 may further include one or more other components not pertinent to the proposed scheme of the present disclosure (e.g., internal power supply, display device and/or user interface device), and, thus, such component(s) of apparatus 910 and apparatus 920 are neither shown in FIG. 9 nor described below in the interest of simplicity and brevity.

In one aspect, each of processor 912 and processor 922 may be implemented in the form of one or more single-core processors, one or more multi-core processors, one or more RISC processors or one or more CISC processors. That is, even though a singular term “a processor” is used herein to refer to processor 912 and processor 922, each of processor 912 and processor 922 may include multiple processors in some implementations and a single processor in other implementations in accordance with the present disclosure. In another aspect, each of processor 912 and processor 922 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 912 and processor 922 is a special-purpose machine specifically designed, arranged and configured to perform specific tasks including those pertaining to designs of multi-RU wider bandwidth PPDU for next-generation WLANs in accordance with various implementations of the present disclosure.

In some implementations, apparatus 910 may also include a transceiver 916 coupled to processor 912. Transceiver 916 may include a transmitter capable of wirelessly transmitting and a receiver capable of wirelessly receiving data. In some implementations, apparatus 920 may also include a transceiver 926 coupled to processor 922. Transceiver 926 may include a transmitter capable of wirelessly transmitting and a receiver capable of wirelessly receiving data. It is noteworthy that, although transceiver 916 and transceiver 926 are illustrated as being external to and separate from processor 912 and processor 922, respectively, in some implementations, transceiver 916 may be an integral part of processor 912 as a system on chip (SoC), and transceiver 926 may be an integral part of processor 922 as a SoC.

In some implementations, apparatus 910 may further include a memory 914 coupled to processor 912 and capable of being accessed by processor 912 and storing data therein. In some implementations, apparatus 920 may further include a memory 924 coupled to processor 922 and capable of being accessed by processor 922 and storing data therein. Each of memory 914 and memory 924 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 914 and memory 924 may include a type of read- only memory (ROM) such as mask ROM, programmable ROM (PROM), erasable programmable ROM (EPROM) and/or electrically erasable programmable ROM (EEPROM). Alternatively, or additionally, each of memory 914 and memory 924 may include a type of non-volatile random- access memory (NVRAM) such as flash memory, solid-state memory, ferroelectric RAM (FeRAM), magnetoresistive RAM (MRAM) and/or phase-change memory.

Each of apparatus 910 and apparatus 920 may be a communication entity capable of communicating with each other using various proposed schemes in accordance with the present disclosure. For illustrative purposes and without limitation, a description of capabilities of apparatus 910, as STA 110, and apparatus 920, as STA 120, is provided below. It is noteworthy that, although a detailed description of capabilities, functionalities and/or technical features of apparatus 920 is provided below, the same may be applied to apparatus 910 although a detailed description thereof is not provided solely in the interest of brevity. It is also noteworthy that, although the example implementations described below are provided in the context of WLAN, the same may be implemented in other types of networks.

Under various proposed schemes pertaining to designs of multi-RU wider bandwidth PPDU for next-generation WLANs in accordance with the present disclosure, with apparatus 910 implemented in or as STA 110 and apparatus 920 implemented in or as STA 120 in network environment 100, processor 912 of apparatus 910 may generate one or more small-size MRUs or one or more large-size MRUs, or a combination thereof, of a PPDU (e.g., OFDM PPDU or non-OFDM PPDU) in a wide bandwidth greater than 80MHz. Each of the one or more small-size MRUs may include an aggregate of multiple RUs of 106 tones or fewer. Each of the one or more large-size MRUs may include an aggregate of multiple RUs of 242 tones or more. Moreover, processor 912 may wirelessly transmit, via transceiver 916, the PPDU in the wide bandwidth (e.g., transmitting to and/or receiving from apparatus 920).

In some implementations, the wide bandwidth may include a 240MHz, 480MHz or 640MHz bandwidth. Moreover, the PPDU may include a 240MHz, 480MHz or 640MHz PPDU.

In some implementations, in generating the one or more small-size MRUs, processor 912 may generate the one or more small-size MRUs in each 80MHz frequency subblock of the wide bandwidth. Moreover, in generating the one or more large-size MRUs, processor 912 may generate the one or more large-size MRUs in each 80MHz frequency subblock, each v160MHz frequency subblock or each 320MHz frequency subblock of the wide bandwidth.

In some implementations, in generating the one or more small-size MRUs, processor 912 may generate at least one of the following: (a) an aggregate of one 52-tone RU and one 26-tone RU (MRU(52+26)) in each 80MHz frequency subblock of a 240MHz, 480MHz or 640MHz PPDU; and (b) an aggregate of one 106-tone RU and one 26-tone RU (MRU(106+26)) in each 80MHz frequency subblock of the 240MHz, 480MHz or 640MHz PPDU.

In some implementations, in generating the one or more large-size MRUs, processor 912 may generate at least one of the following: (a) an aggregate of one 484-tone RU and one 242-tone RU (MRU(484+242)) in each 80MHz frequency subblock of a 240MHz, 480MHz or 640MHz PPDU; (b) an aggregate of one 996-tone RU and one 484-tone RU (MRU(996+484)) in each 160MHz frequency subblock of the 240MHz, 480MHz or 640MHz PPDU; (c) an aggregate of one 996-tone RU and one 484-tone RU and one 242-tone RU (MRU(996+484+242)) in each 160MHz frequency subblock of the 240MHz, 480MHz or 640MHz PPDU; (d) an aggregate of two 996-tone RUs and one 484-tone RU (MRU(2×996+484)) in each 320MHz frequency subblock of a 480MHz or 640MHz PPDU; (e) an aggregate of three 996-tone RUs and one 484-tone RU (MRU(3×996+484)) in each 320MHz frequency subblock of the 480MHz or 640MHz PPDU; (f) an aggregate of two 996-tone RUs (MRU(2×996)) in each 320MHz frequency subblock of the 480MHz or 640MHz PPDU; (g) an aggregate of three 996-tone RUs (MRU(3×996)) in each 320MHz frequency subblock of the 480MHz or 640MHz PPDU; (h) an aggregate of four 996-tone RUs (MRU(4×996)) in a 480MHz or 640MHz PPDU; (i) an aggregate of five 996-tone RUs (MRU(5×996)) in the 480MHz or 640MHz PPDU; (j) an aggregate of six 996-tone RUs (MRU(6×996)) in the 640MHz PPDU; and (k) an aggregate of seven 996-tone RUs (MRU(7×996)) in the 640MHz PPDU.

In some implementations, in generating the one or more large-size MRUs, processor 912 may generate at least one aggregate of two 996-tone RUs and one 484-tone RU (MRU(2×996+484)) and at least one aggregate of two 996-tone RUs (MRU(2×996)) in a 240MHz bandwidth.

In some implementations, in generating the one or more large-size MRUs, processor 912 may perform certain operations. For instance, processor 912 may generate at least one aggregate of five 996-tone RUs (MRU(5×996), at least one aggregate of four 996-tone RUs (MRU(4×996)) and at least one aggregate of three 996-tone RUs (MRU(3×996)) in a 480MHz bandwidth. Additionally, processor 912 may generate the one or more large-size MRUs with a SCS of 78.125 kHz.

In some implementations, in generating the one or more large-size MRUs, processor 912 may perform certain operations. For instance, processor 912 may generate at least one aggregate of seven 996-tone RUs (MRU(7×996), at least one aggregate of six 996-tone RUs (MRU(6×996)) and at least one aggregate of four 996-tone RUs (MRU(4×996)) in a 640MHz bandwidth.

Moreover, processor 912 may generate the one or more large-size MRUs with a SCS of 78.125 kHz. Furthermore, processor 912 may puncture a contiguous 320MHz hole out of the 640MHz bandwidth in generating the at least one MRU(4×996). Alternatively, processor 912 may puncture two contiguous 160MHz holes out of the 640MHz bandwidth in generating the at least one MRU(4×996).

In some implementations, in generating the one or more large-size MRUs, processor 912 may perform certain operations. For instance, processor 912 may generate at least one aggregate of five 996-tone RUs (MRU(5×996), at least one aggregate of four 996-tone RUs (MRU(4×996)) and at least one aggregate of three 996-tone RUs (MRU(3×996)) in a 640MHz bandwidth. Additionally, processor 912 may generate the one or more large-size MRUs with a SCS of 78.125 kHz. Moreover, processor 912 may puncture a contiguous 160MHz hole out of the 640MHz bandwidth.

### Illustrative Processes

FIG. 10 illustrates an example process 1000 in accordance with an implementation of the present disclosure. Process 1000 may represent an aspect of implementing various proposed designs, concepts, schemes, systems and methods described above. More specifically, process 1000 may represent an aspect of the proposed concepts and schemes pertaining to designs of multi-RU wider bandwidth PPDU for next-generation WLANs in accordance with the present disclosure. Process 1000 may include one or more operations, actions, or functions as illustrated by one or more of blocks 1010 and 1020. Although illustrated as discrete blocks, various blocks of process 1000 may be divided into additional blocks, combined into fewer blocks, or eliminated, depending on the desired implementation. Moreover, the blocks/sub-blocks of process 1000 may be executed in the order shown in FIG. 10 or, alternatively in a different order. Furthermore, one or more of the blocks/sub-blocks of process 1000 may be executed repeatedly or iteratively. Process 1000 may be implemented by or in apparatus 910 and apparatus 920 as well as any variations thereof. Solely for illustrative purposes and without limiting the scope, process 1000 is described below in the context of apparatus 910 implemented in or as STA 110 functioning as a non-AP STA and apparatus 920 implemented in or as STA 120 functioning as an AP STA of a wireless network such as a WLAN in network environment 100 in accordance with one or more of IEEE 802.11 standards. Process 1000 may begin at block 1010.

At 1010, process 1000 may involve processor 912 of apparatus 910 generating one or more small-size MRUs or one or more large-size MRUs, or a combination thereof, of a PPDU (e.g., OFDM PPDU or non-OFDM PPDU) in a wide bandwidth greater than 80MHz. Each of the one or more small-size MRUs may include an aggregate of multiple RUs of 106 tones or fewer. Each of the one or more large-size MRUs may include an aggregate of multiple RUs of 242 tones or more. Process 1000 may proceed from 1010 to 1020.

At 1020, process 1000 may involve processor 912 wirelessly transmitting, via transceiver 916, the PPDU in the wide bandwidth (e.g., transmitting to and/or receiving from apparatus 920).

In some implementations, the wide bandwidth may include a 240MHz, 480MHz or 640MHz bandwidth. Moreover, the PPDU may include a 240MHz, 480MHz or 640MHz PPDU.

In some implementations, in generating the one or more small-size MRUs, process 1000 may involve processor 912 generating the one or more small-size MRUs in each 80MHz frequency subblock of the wide bandwidth. Moreover, in generating the one or more large-size MRUs, process 1000 may involve processor 912 generating the one or more large-size MRUs in each 80MHz frequency subblock, each 160MHz frequency subblock or each 320MHz frequency subblock of the wide bandwidth.

In some implementations, in generating the one or more small-size MRUs, process 1000 may involve processor 912 generating at least one of the following: (a) an aggregate of one 52-tone RU and one 26-tone RU (MRU(52+26)) in each 80MHz frequency subblock of a 240MHz, 480MHz or 640MHz PPDU; and (b) an aggregate of one 106-tone RU and one 26-tone RU (MRU(106+26)) in each 80MHz frequency subblock of the 240MHz, 480MHz or 640MHz PPDU.

In some implementations, in generating the one or more large-size MRUs, process 1000 may involve processor 912 generating at least one of the following: (a) an aggregate of one 484-tone RU and one 242-tone RU (MRU(484+242)) in each 80MHz frequency subblock of a 240MHz, 480MHz or 640MHz PPDU; (b) an aggregate of one 996-tone RU and one 484-tone RU (MRU(996+484)) in each 160MHz frequency subblock of the 240MHz, 480MHz or 640MHz PPDU; (c) an aggregate of one 996-tone RU and one 484-tone RU and one 242-tone RU (MRU(996+484+242)) in each 160MHz frequency subblock of the 240MHz, 480MHz or 640MHz PPDU; (d) an aggregate of two 996-tone RUs and one 484-tone RU (MRU(2×996+484)) in each 320MHz frequency subblock of a 480MHz or 640MHz PPDU; (e) an aggregate of three 996-tone RUs and one 484-tone RU (MRU(3×996+484)) in each 320MHz frequency subblock of the 480MHz or 640MHz PPDU; (f) an aggregate of two 996-tone RUs (MRU(2×996)) in each 320MHz frequency subblock of the 480MHz or 640MHz PPDU; (g) an aggregate of three 996-tone RUs (MRU(3×996)) in each 320MHz frequency subblock of the 480MHz or 640MHz PPDU; (h) an aggregate of four 996-tone RUs (MRU(4×996)) in a 480MHz or 640MHz PPDU; (i) an aggregate of five 996-tone RUs (MRU(5×996)) in the 480MHz or 640MHz PPDU; (j) an aggregate of six 996-tone RUs (MRU(6×996)) in the 640MHz PPDU; and (k) an aggregate of seven 996-tone RUs (MRU(7×996)) in the 640MHz PPDU.

In some implementations, in generating the one or more large-size MRUs, process 1000 may involve processor 912 generating at least one aggregate of two 996-tone RUs and one 484-tone RU (MRU(2×996+484)) and at least one aggregate of two 996-tone RUs (MRU(2×996)) in a 240MHz bandwidth.

In some implementations, in generating the one or more large-size MRUs, process 1000 may involve processor 912 performing certain operations. For instance, process 1000 may involve processor 912 generating at least one aggregate of five 996-tone RUs (MRU(5×996), at least one aggregate of four 996-tone RUs (MRU(4×996)) and at least one aggregate of three 996-tone RUs (MRU(3×996)) in a 480MHz bandwidth. Additionally, process 1000 may involve processor 912 generating the one or more large-size MRUs with a SCS of 78.125 kHz.

In some implementations, in generating the one or more large-size MRUs, process 1000 may involve processor 912 performing certain operations. For instance, process 1000 may involve processor 912 generating at least one aggregate of seven 996-tone RUs (MRU(7×996), at least one aggregate of six 996-tone RUs (MRU(6×996)) and at least one aggregate of four 996-tone RUs (MRU(4×996)) in a 640MHz bandwidth. Moreover, process 1000 may involve processor 912 generating the one or more large-size MRUs with a SCS of 78.125 kHz. Furthermore, process 1000 may involve processor 912 puncturing a contiguous 320MHz hole out of the 640MHz bandwidth in generating the at least one MRU(4×996). Alternatively, process 1000 may involve processor 912 puncturing two contiguous 160MHz holes out of the 640MHz bandwidth in generating the at least one MRU(4×996).

In some implementations, in generating the one or more large-size MRUs, process 1000 may involve processor 912 performing certain operations. For instance, process 1000 may involve processor 912 generating at least one aggregate of five 996-tone RUs (MRU(5×996), at least one aggregate of four 996-tone RUs (MRU(4×996)) and at least one aggregate of three 996-tone RUs (MRU(3×996)) in a 640MHz bandwidth. Additionally, process 1000 may involve processor 912 generating the one or more large-size MRUs with a SCS of 78.125 kHz. Moreover, process 1000 may involve processor 912 puncturing a contiguous 160MHz hole out of the 640MHz bandwidth.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
generating one or more small-size multi-resource units (MRUs) or one or more large-size MRUs, or a combination thereof, of a physical-layer protocol data unit (PPDU) in a wide bandwidth greater than 80MHz; and
wirelessly transmitting the PPDU in the wide bandwidth,
wherein each of the one or more small-size MRUs comprises an aggregate of multiple RUs of 106 tones or fewer, and
wherein each of the one or more large-size MRUs comprises an aggregate of multiple RUs of 242 tones or more.

2. The method of claim 1, wherein the wide bandwidth comprises a 240MHz, 480MHz or 640MHz bandwidth, and wherein the PPDU comprises a 240MHz, 480MHz or 640MHz PPDU.

3. The method of claim 1, wherein the generating of the one or more small-size MRUs comprises generating the one or more small-size MRUs in each 80MHz frequency subblock of the wide bandwidth, and wherein the generating of the one or more large-size MRUs comprises generating the one or more large-size MRUs in each 80MHz frequency subblock, each 160MHz frequency subblock or each 320MHz frequency subblock of the wide bandwidth.

4. The method of claim 1, wherein the generating of the one or more small-size MRUs comprise generating at least one of:
an aggregate of one 52-tone resource unit (RU) and one 26-tone RU (MRU(52+26)) in each 80MHz frequency subblock of a 240MHz, 480MHz or 640MHz PPDU; and
an aggregate of one 106-tone RU and one 26-tone RU (MRU(106+26)) in each 80MHz frequency subblock of the 240MHz, 480MHz or 640MHz PPDU.

5. The method of claim 1, wherein the generating of the one or more large-size MRUs comprise generating at least one of:
an aggregate of one 484-tone resource unit (RU) and one 242-tone RU (MRU(484+242)) in each 80MHz frequency subblock of a 240MHz, 480MHz or 640MHz PPDU;
an aggregate of one 996-tone RU and one 484-tone RU (MRU(996+484)) in each 160MHz frequency subblock of the 240MHz, 480MHz or 640MHz PPDU;
an aggregate of one 996-tone RU and one 484-tone RU and one 242-tone RU (MRU(996+484+242)) in each 160MHz frequency subblock of the 240MHz, 480MHz or 640MHz PPDU;
an aggregate of two 996-tone RUs and one 484-tone RU (MRU(2×996+484)) in each 320MHz frequency subblock of a 480MHz or 640MHz PPDU;
an aggregate of three 996-tone RUs and one 484-tone RU (MRU(3×996+484)) in each 320MHz frequency subblock of the 480MHz or 640MHz PPDU;
an aggregate of two 996-tone RUs (MRU(2×996)) in each 320MHz frequency subblock of the 480MHz or 640MHz PPDU;
an aggregate of three 996-tone RUs (MRU(3×996)) in each 320MHz frequency subblock of the 480MHz or 640MHz PPDU;
an aggregate of four 996-tone RUs (MRU(4×996)) in a 480MHz or 640MHz PPDU;
an aggregate of five 996-tone RUs (MRU(5×996)) in the 480MHz or 640MHz PPDU;
an aggregate of six 996-tone RUs (MRU(6×996)) in the 640MHz PPDU; and
an aggregate of seven 996-tone RUs (MRU(7×996)) in the 640MHz PPDU.

6. The method of claim 1, wherein the generating of the one or more large-size MRUs comprise generating at least one aggregate of two 996-tone RUs and one 484-tone RU (MRU(2×996+484)) and at least one aggregate of two 996-tone RUs (MRU(2×996)) in a 240MHz bandwidth.

7. The method of claim 1, wherein the generating of the one or more large-size MRUs comprise generating at least one aggregate of five 996-tone RUs (MRU(5×996), at least one aggregate of four 996-tone RUs (MRU(4×996)) and at least one aggregate of three 996-tone RUs (MRU(3×996)) in a 480MHz bandwidth.

8. The method of claim 7, wherein the generating of the one or more large-size MRUs further comprise generating the one or more large-size MRUs with a subcarrier spacing (SCS) of 78.125 kHz.

9. The method of claim 1, wherein the generating of the one or more large-size MRUs comprise generating at least one aggregate of seven 996-tone RUs (MRU(7×996), at least one aggregate of six 996-tone RUs (MRU(6×996)) and at least one aggregate of four 996-tone RUs (MRU(4×996)) in a 640MHz bandwidth.

10. The method of claim 9, wherein the generating of the one or more large-size MRUs further comprise generating the one or more large-size MRUs with a subcarrier spacing (SCS) of 78.125 kHz.

11. The method of claim 9, wherein the generating of the at least one MRU(4×996) comprises puncturing a contiguous 320MHz hole out of the 640MHz bandwidth.

12. The method of claim 9, wherein the generating of the at least one MRU(4×996) comprises puncturing two contiguous 160MHz holes out of the 640MHz bandwidth.

13. The method of claim 1, wherein the generating of the one or more large-size MRUs comprise generating at least one aggregate of five 996-tone RUs (MRU(5×996), at least one aggregate of four 996-tone RUs (MRU(4×996)) and at least one aggregate of three 996-tone RUs (MRU(3×996)) in a 640MHz bandwidth.

14. The method of claim 13, wherein the generating of the one or more large-size MRUs further comprise generating the one or more large-size MRUs with a subcarrier spacing (SCS) of 78.125 kHz.

15. The method of claim 13, wherein the generating of the one or more large-size MRUs further comprises puncturing a contiguous 160MHz hole out of the 640MHz bandwidth.

16. An apparatus, comprising:
a transceiver configured to communicate wirelessly; and
a processor coupled to the transceiver and configured to perform operations comprising:
generating one or more small-size multi-resource units (MRUs) or one or more large-size MRUs, or a combination thereof, of a physical-layer protocol data unit (PPDU) in a wide bandwidth greater than 80MHz; and
wirelessly transmitting, via the transceiver, the PPDU in the wide bandwidth, wherein each of the one or more small-size MRUs comprises an aggregate of multiple RUs of 106 tones or fewer, and
wherein each of the one or more large-size MRUs comprises an aggregate of multiple RUs of 242 tones or more.

17. The apparatus of claim 16, wherein the wide bandwidth comprises a 240MHz, 480MHz or 640MHz bandwidth, and wherein the PPDU comprises a 240MHz, 480MHz or 640MHz PPDU.

18. The apparatus of claim 16, wherein the generating of the one or more small-size MRUs comprises generating the one or more small-size MRUs in each 80MHz frequency subblock of the wide bandwidth, and wherein the generating of the one or more large-size MRUs comprises generating the one or more large-size MRUs in each 80MHz frequency subblock, each 160MHz frequency subblock or each 320MHz frequency subblock of the wide bandwidth.

19. The apparatus of claim 16, wherein the generating of the one or more small-size MRUs comprise generating at least one of:
an aggregate of one 52-tone resource unit (RU) and one 26-tone RU (MRU(52+26)) in each 80MHz frequency subblock of a 240MHz, 480MHz or 640MHz PPDU; and
an aggregate of one 106-tone RU and one 26-tone RU (MRU(106+26)) in each 80MHz frequency subblock of the 240MHz, 480MHz or 640MHz PPDU.

20. The apparatus of claim 16, wherein the generating of the one or more large-size MRUs comprise generating at least one of:
an aggregate of one 484-tone resource unit (RU) and one 242-tone RU (MRU(484+242)) in each 80MHz frequency subblock of a 240MHz, 480MHz or 640MHz PPDU;
an aggregate of one 996-tone RU and one 484-tone RU (MRU(996+484)) in each 160MHz frequency subblock of the 240MHz, 480MHz or 640MHz PPDU;
an aggregate of one 996-tone RU and one 484-tone RU and one 242-tone RU (MRU(996+484+242)) in each 160 MHz frequency subblock of the 240MHz, 480MHz or 640MHz PPDU;
an aggregate of two 996-tone RUs and one 484-tone RU (MRU(2×996+484)) in each 320MHz frequency subblock of a 480MHz or 640MHz PPDU;
an aggregate of three 996-tone RUs and one 484-tone RU (MRU(3×996+484)) in each 320MHz frequency subblock of the 480MHz or 640MHz PPDU;
an aggregate of two 996-tone RUs (MRU(2×996)) in each 320MHz frequency subblock of the 480MHz or 640MHz PPDU;
an aggregate of three 996-tone RUs (MRU(3×996)) in each 320MHz frequency subblock of the 480MHz or 640MHz PPDU;
an aggregate of four 996-tone RUs (MRU(4×996)) in a 480MHz or 640MHz PPDU;
an aggregate of five 996-tone RUs (MRU(5×996)) in the 480MHz or 640MHz PPDU;
an aggregate of six 996-tone RUs (MRU(6×996)) in the 640MHz PPDU; and
an aggregate of seven 996-tone RUs (MRU(7×996)) in the 640MHz PPDU.
